(19) United States
(12) Patent Application Publication
(10) Pub. No.: US 2005/0289480 A1
(43) Pub. Date: Dec. 29, 2005

(54) Method and apparatus to reduce navigational keystrokes in electronic devices

(75) Inventors: Ajit Mathews, Plantation, FL (US); Mahesh B. Bhuta, Coral Springs, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 10/877,257

(22) Filed: Jun. 25, 2004

(51) Int. Cl. G06F 3/00

(52) U.S. Cl. 715/821; 715/773; 715/827; 715/825; 715/708

(57) ABSTRACT

A method (60) of reducing navigational keystrokes on an electronic device includes the steps of displaying (61) a plurality of options and associated references on a graphical user interface, dynamically associating (62) at least one among the plurality of options with at least one among the associated references, and activating (63) a desired option by activating an input on an input device having a corresponding reference. Note, the associated references correspond to references illustrated on the input device. The method can further calculate (64) a number of zones based on the number of options to be presented among the plurality of options. The number of zones can be calculated (65) based on the size of an image when the plurality of options to be presented is images or alternatively be calculated (66) based on the size of the font size when the plurality of options to be presented is textual.

### FIELD OF THE INVENTION

This invention relates generally to user interfaces (UIs), and more particularly to a method and system for reducing keystrokes in electronic devices.

### BACKGROUND OF THE INVENTION

As mobile devices and other electronic appliances become increasingly feature rich, their respective user interfaces are getting more complex. Marketing studies have indicated that approximately 90% of the users seem to be using 10% of the features available. Part of the blame can be placed on the complexity of the overall user interface and more specifically because users get lost in the Main Menu or Application Menus or because so many keystrokes are required to reach a desired application or option. Since many products today are designed to satisfy the needs of many, an inordinate amount of logical options are provided for Main menus and Application menus. Unfortunately, the numerous options result in a significant number of key presses or steps for all users.

Existing UIs use soft/hot keys to allow a user a direct link to some applications. The existing soft/hot keys are sometimes user programmable, but remain static once programmed by the user. Soft/hot keys help the user to reduce the number of keystrokes to execute a desired application and to optimize the UI based on the features/applications available and their intended use. Unfortunately, since existing soft/hot key features are static, no consideration is given by the soft/hot key function to the context in which a user is currently operating a device. Existing hot/soft keys fail to take full advantage of the user interfaces and input devices readily available to them. In this regards, existing hot/soft keys features fail to provide a dynamically changing hot/soft key function based on changing context, particularly in terms of different applications.

For example, accessing a desired feature or application in a phone requires multiple navigations using navigational (up/down and/or Left/Right) keys. An Iconic Main menu screen 10 for a mobile phone as shown in FIGS. 1 and 2 is used to illustrate and describe the problem. The main menu can have a multiple number of items which can include phone applications and Java Midlets that a user can add to the main menu. A user can also potentially bookmark their favorite sites (in a web browsing context) which can then show up as one of the main menu items. For example, assume that the Main menu has 40 Items of which only a portion can be seen on any one screen at a time. Referring to FIG. 1, the main menu screen 10 only illustrates 16 menu items. In order to launch the option or item number 11, a user needs a minimum of 5 key presses (4 scrolling presses+one OK key press or SELECT softkey press). In another example as best illustrated by FIG. 2, the main menu screen 10 has a viewable area 15 of the screen and a remaining list of items 20. If a user desires to launch the option or item number 22, which would be on a subsequent page of the screen, then the user needs to make a minimum of 5 key presses (one softkey press to get the next page+3 scrolling presses+one OK key press or SELECT softkey press). The increase in the number of rows and columns is directly proportional to the display size and also the number of items in a list. The number of key presses required to navigate through menus will only increase as the number of rows and columns increase to accommodate additional items. Furthermore, any device having limited navigation keys (as in certain phone models that only have Up/Down keys or only Left/Right keys) will also increase the number of keystrokes required to navigate through menus and lists.

### SUMMARY OF THE INVENTION

Embodiments in accordance with the present invention can provide users of electronic devices such as mobile phone users with a user interface that requires less keystrokes to navigate between options available on the electronic device. Such options can be various applications available on the electronic device or a list of phonebook entries in an electronic phonebook for example. Although not limited thereto, the techniques disclosed and claimed herein can be used with and applied to most wireless devices having different input devices such as keypads, touch-screens or even voice recognition input mechanisms.

In a first embodiment of the present invention, a method of reducing navigational keystrokes on an electronic device can include the steps of displaying a plurality of options (such as applications) and associated references (such as associated numbers that correspond to numbers on a keypad serving as an input device) on a graphical user interface, dynamically associating at least one among the plurality of options with at least one among the associated references, and activating a desired option among the plurality of options displayed by activating an input on the input device having a corresponding reference. Note, the associated references correspond to references illustrated on the input device. The method can further include the step of calculating a number of zones based on the number of options to be presented among the plurality of options. The number of zones can be calculated based on the size of an image when the plurality of options to be presented is images or alternatively the number of zones can be calculated based on the size of the font size when the plurality of options to be presented is textual. In this regard, note that the step of dynamically associating can include the step of assigning a numbered image or a numbered textual option representing an option to each of the zones.

In a second embodiment of the present invention, another method of reducing navigational keystrokes using a graphical user interface on a display can include the steps of displaying a plurality of options and an associated number or a series of numbers corresponding to numbers on a keypad, dynamically arranging the options alphanumerically to facilitate easy searching of the options to be presented, and, activating a selected option among the options by activating a key on the keypad having a corresponding number corresponding to the selected option. The method can further include the step of calculating a number of zones on the display based on a number of options to be presented among the plurality of options. The number of zones can be calculated based on the size of an image when the plurality of options to be presented is images or the number of zones can be calculated based on the size of the font size when the plurality of options to be presented is textual.

In a third embodiment of the present invention, a system for reducing navigational keystrokes on an electronic device having a graphical user interface on a display can include a user input device, an encoder for encoding entries using the user input device, and a processor coupled to the user input device and the encoder. The processor can be programmed to display a plurality of options and associated references on the graphical user interface, dynamically associate at least one among the plurality of options with at least one among the associated references, and activate a desired option among the plurality of options displayed by activating an input on a input device having a corresponding reference. Note, the associated references correspond to references illustrated on the user input device. The processor can be further programmed to calculate a number of zones based on the number of options to be presented among the plurality of options. The number of zones can be calculated based on the size of an image when the plurality of options to be presented is images and based on the size of the font size when the plurality of options to be presented is textual.

In a fourth embodiment of the present invention, a system for reducing navigational keystrokes on an electronic device having a graphical user interface on a display can include a keypad, an encoder for encoding entries using the user input device, and a processor coupled to the keypad and the encoder. The processor can be programmed to display a plurality of options and an associated number or a series of numbers corresponding to numbers on the keypad, dynamically arrange the options alphanumerically to facilitate easy searching of the options to be presented, and activate a selected option among the options by activating a key on the keypad having a corresponding number corresponding to the selected option.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is an illustration of an existing menu screen and the navigational keystrokes need for a selection of an option or item on the screen.

FIG. 2 is another illustration of the menu screen of FIG. 1.

FIG. 3 is an illustration of a menu screen in accordance with an embodiment of the present invention.

FIG. 4 is an illustration of a second page of a menu screen in accordance with an embodiment of the present invention.

FIG. 5 is an illustration of a menu screen and alphanumeric ordering of options or items in accordance with an embodiment of the present invention.

FIG. 6 is a flow chart illustrating a method of reducing keystrokes in electronic devices in accordance with an embodiment of the present invention.

FIG. 7 is a flow chart illustrating another method of reducing keystrokes in electronic devices in accordance with an embodiment of the present invention

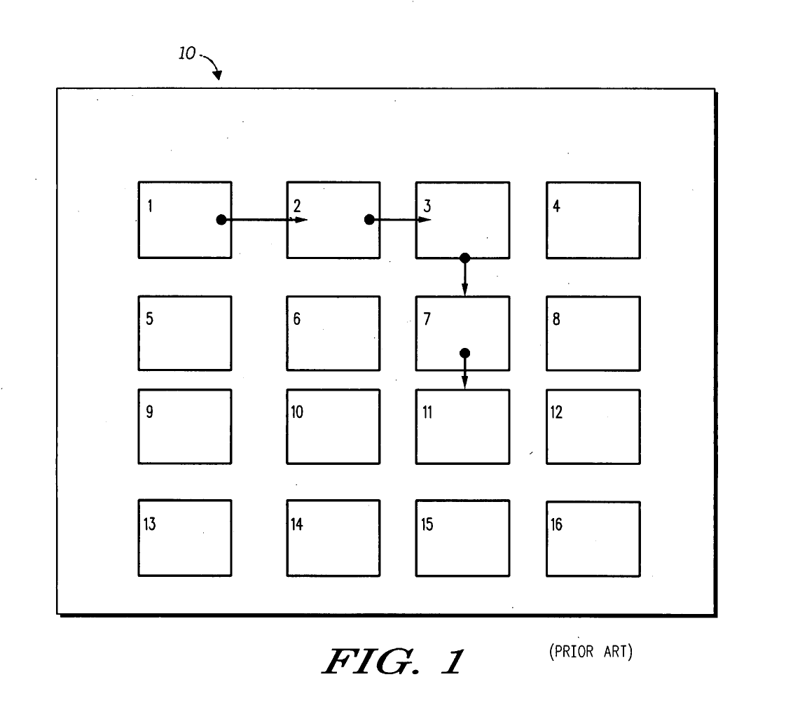

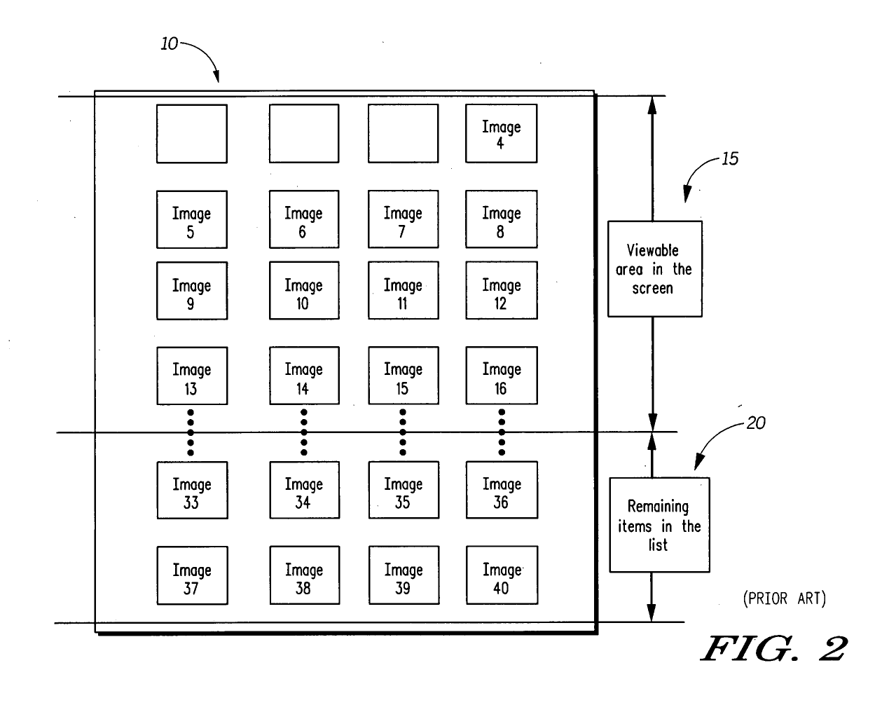

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

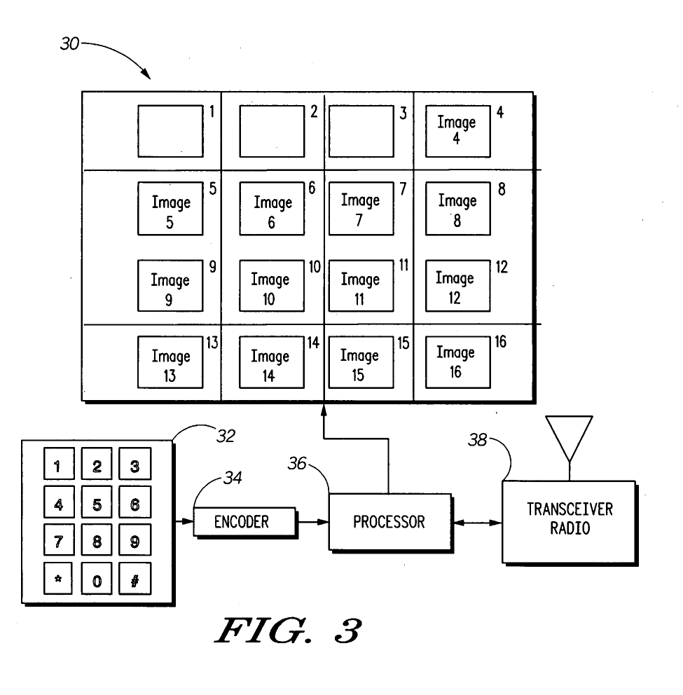

Referring to FIG. 3, a visible area of a screen 30 is shown as divided into different application zones. The screen 30 can be a portion of an electronic device such as a mobile or cellular phone having a input device such as a keypad 32, an encoder 34, a processor 36 and a transceiver radio 38. In this example, there are 16 zones, zones 1-16. Each of these zones can then be assigned numbered options in the form of images or text. In the embodiments of FIGS. 3 and 4, each zone is assigned numbered images (42) to associate with an item on the screen. These images are used as a visual aid to the user indicating the relation of a key pressed with an application. By means of a software algorithm, when the user presses the key, the application (or item) 44 associated with that key is launched or selected.

Referring again to FIG. 3, if a user desires to launch an application representative of the image illustrated in zone 15, a user would only need to press on a keypad or some other user input device the number 1 followed by the number 5 to launch the application. In this scenario, only two key presses are required instead of five key presses in existing navigational systems. In another scenario where an item might be on a subsequent page, for example, where the user desires to launch an application or item number 22, a user would need to press a softkey to bring the subsequent or new set of items into the visible area. The new set of items can then be mapped to the application zones. In this example as illustrated by a screen 40 in FIG. 4, the user only needs to then press the “6” key to launch the application or item number 22. Once again, the user is able to launch the application item using two key presses (one softkey press to get the next page+one item key) rather than 5 key presses.

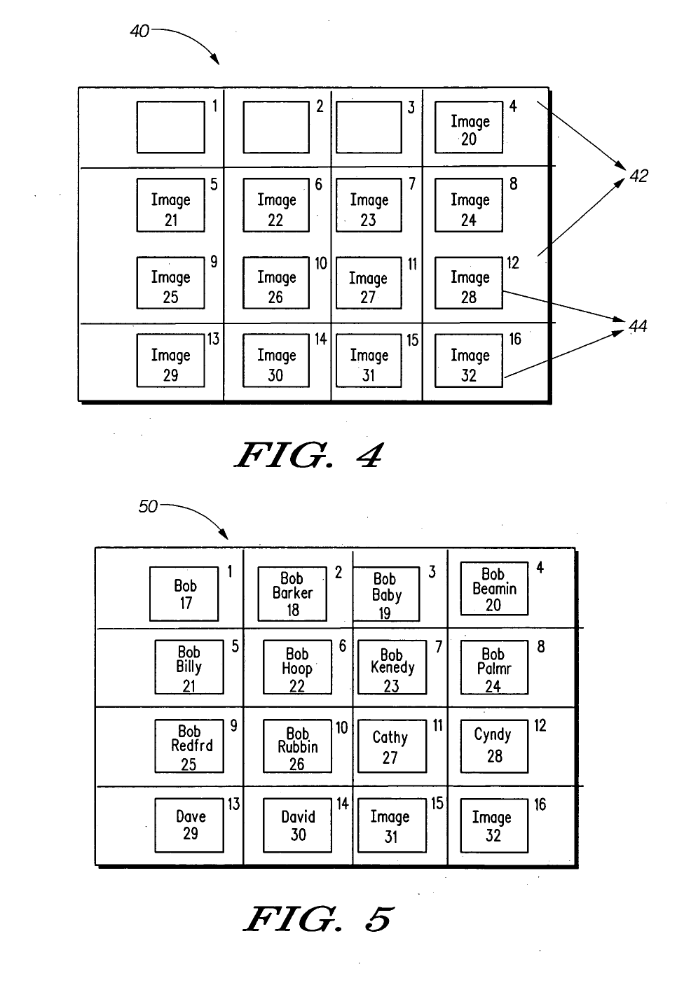

Referring to FIG. 5, another screen 50 illustrates how the concepts above with the addition of alphanumeric searching provides a powerful tool for user interfaces. For example, such a tool can truly reduce the number of keystrokes for users in a device that had the capability to present a myriad of options or items. In a device capable of having 400 multimedia files (Images, Video and Audio) in its media center application, for example, an embodiment in accordance with the invention can enable a user to easily search for a desired application or item using a combination of alphanumeric searching and indexed or zoned iconic images or textual entries that can be selected as associated with a user input such as a typical phone keypad. Phonebook entries displayed in this manner as illustrated in FIG. 5 that associate an image or textual information with a particular zone and further provide alphanumeric searching can help the user to reach a desired item with a minimal number of key presses.

Where alphanumeric searching is provided, phonebook entries can be found and selected quickly with a reduced number of keystrokes. If a user has a large phonebook with numerous entries (for example, over 100 entries) of which 10 entries include the name “Bob” as a first name for example, an embodiment in accordance with the present invention would enable a user to find a desired item quickly as illustrated in FIG. 5. By pressing the letters “BO”, the user can see all the entries and can call the desired “Bob” by at most two additional key presses.

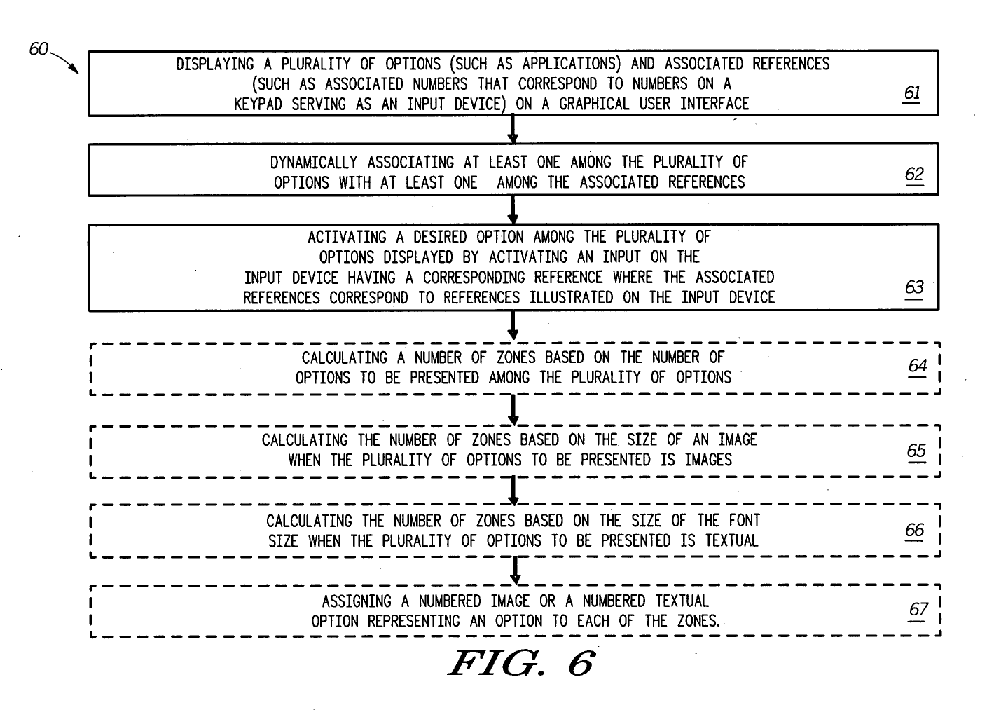

Referring to FIG. 6, a flow chart illustrating a method 60 of reducing navigational keystrokes on an electronic device can include the steps of displaying a plurality of options (such as applications) and associated references (such as associated numbers that correspond to numbers on a keypad serving as an input device) on a graphical user interface at step 61, dynamically associating at step 62 at least one among the plurality of options with at least one among the associated references, and activating a desired option among the plurality of options displayed by activating an input on the input device having a corresponding reference at step 63. Note, the associated references correspond to references illustrated on the input device. The method 60 can further include the step of calculating a number of zones based on the number of options to be presented among the plurality of options at step 64. The number of zones can be calculated based on the size of an image at step 65 when the plurality of options to be presented is images or alternatively the number of zones can be calculated based on the size of the font size at step 66 when the plurality of options to be presented is textual. In this regard, note that the step of dynamically associating can include the step of assigning a numbered image or a numbered textual option representing an option to each of the zones at step 67.

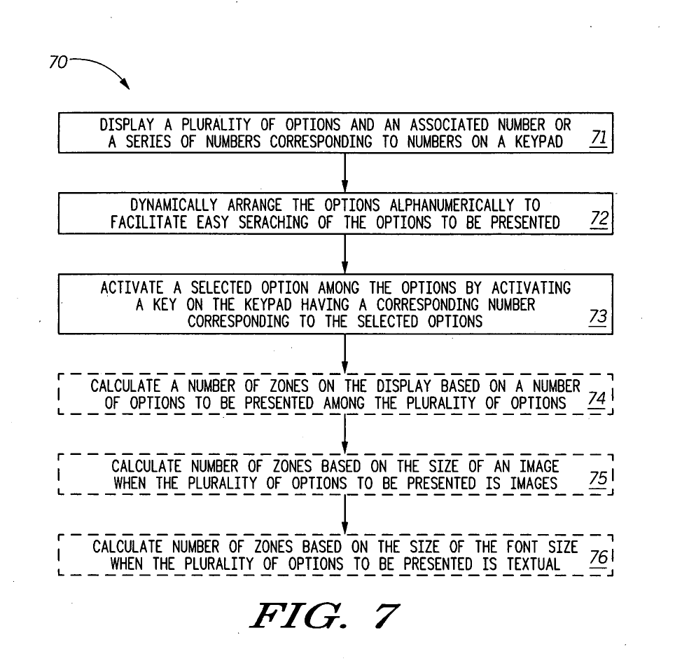

Referring to FIG. 7, a flow chart illustrating another method 70 of reducing navigational keystrokes using a graphical user interface on a display can include the steps of displaying a plurality of options and an associated number or a series of numbers corresponding to numbers on a keypad at step 71, dynamically arranging at step 72 the options alphanumerically to facilitate easy searching of the options to be presented, and, activating a selected option among the options by activating a key on the keypad having a corresponding number corresponding to the selected option at step 73. The method can further include the step of calculating a number of zones on the display based on a number of options to be presented among the plurality of options at step 74. The number of zones can be calculated based on the size of an image at step 75 when the plurality of options to be presented is images or the number of zones can be calculated based on the size of the font size at step 76 when the plurality of options to be presented is textual.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

1. A method of reducing navigational keystrokes on an electronic device, comprising the steps of:
displaying a plurality of options and associated references on a graphical user interface, wherein the associated references correspond to references illustrated on an input device;
dynamically associating at least one among the plurality of options with at least one among the associated references; and
activating a desired option among the plurality of options displayed by activating an input on the input device having a corresponding reference.

2. The method of claim 1, wherein the step of displaying the plurality of options and associated references comprises the step of displaying a plurality of applications and associated numbers that correspond to numbers on a keypad serving as the input device.

3. The method of claim 1, wherein the method further comprises the step of calculating a number of zones based on the number of options to be presented among the plurality of options.

4. The method of claim 3, wherein the number of zones is calculated based on the size of an image when the plurality of options to be presented is images.

5. The method of claim 3, wherein the number of zones is calculated based on the size of the font size when the plurality of options to be presented is textual.

6. The method of claim 3, wherein the step of dynamically associating comprises the step of assigning a numbered image representing an option to each of the zones.

7. The method of claim 3, wherein the step of dynamically associating comprises the step of assigning a numbered textual option to each of the zones.

8. A method of reducing navigational keystrokes using a graphical user interface on a display, comprising the steps of:
displaying a plurality of options and an associated number or a series of numbers corresponding to numbers on a keypad;
dynamically arranging the options alphanumerically to facilitate easy searching of the options to be presented; and
activating a selected option among the options by activating a key on the keypad having a corresponding number corresponding to the selected option.

9. The method of claim 8, wherein the method further comprises the step of calculating a number of zones on the display based on a number of options to be presented among the plurality of options.

10. The method of claim 9, wherein the number of zones is calculated based on the size of an image when the plurality of options to be presented is images.

11. The method of claim 9, wherein the number of zones is calculated based on the size of the font size when the plurality of options to be presented is textual.

12. The method of claim 9, wherein the step of dynamically arranging comprises the step of assigning a numbered image representing an option to each of the zones.

13. The method of claim 9, wherein the step of dynamically arranging comprises the step of assigning a numbered textual option to each of the zones.

14. A system for reducing navigational keystrokes on an electronic device having a graphical user interface on a display, comprises:
a user input device;
an encoder for encoding entries using the user input device; and
a processor coupled to the user input device and the encoder and programmed to:
display a plurality of options and associated references on the graphical user interface, wherein the associated references correspond to references illustrated on the user input device;
dynamically associate at least one among the plurality of options with at least one among the associated references; and
activate a desired option among the plurality of options displayed by activating an input on the input device having a corresponding reference.

15. The system of claim 14, wherein the processor is further programmed to calculate a number of zones based on the number of options to be presented among the plurality of options.

16. The system of claim 14, wherein the number of zones is calculated based on the size of an image when the plurality of options to be presented is images and based on the size of the font size when the plurality of options to be presented is textual.

17. A system for reducing navigational keystrokes on an electronic device having a graphical user interface on a display, comprising the steps of:
a keypad;
an encoder for encoding entries using the user input device; and
a processor coupled to the keypad and the encoder and programmed to:
display a plurality of options and an associated number or a series of numbers corresponding to numbers on the keypad;
dynamically arrange the options alphanumerically to facilitate searching of the options to be presented; and
activate a selected option among the options by activating a key on the keypad having a corresponding number corresponding to the selected option.

18. A machine readable storage, having stored thereon a computer program having a plurality of code sections executable by a machine for causing the machine to perform the steps of:
displaying a plurality of options and associated references on a graphical user interface, wherein the associated references correspond to references illustrated on an input device;
dynamically associating at least one among the plurality of options with at least one among the associated references; and
activating a desired option among the plurality of options displayed by activating an input on the input device having a corresponding reference.

19. The machine-readable storage of claim 18, the machine-readable storage including code sections for causing the machine to display the plurality of options and associated references by displaying a plurality of applications and associated numbers that correspond to numbers on a keypad serving as the input device.

20. The machine-readable storage of claim 18, the machine-readable storage further including code sections for causing the machine to calculate a number of zones based on the number of options to be presented among the plurality of options.

21. A machine readable storage, having stored thereon a computer program having a plurality of code sections executable by a machine for causing the machine to perform the steps of:
displaying a plurality of options and an associated number or a series of numbers corresponding to numbers on a keypad;
dynamically arranging the options alphanumerically to facilitate searching of the options to be presented; and
activating a selected option among the options by activating a key on the keypad having a corresponding number corresponding to the selected option.
